(19) United States
(12) Patent Application Publication
(10) Pub. No.: US 2025/0174006 A1
(43) Pub. Date: May 29, 2025

(54) VEHICLE CATEGORY CLASSIFICATION FROM SURVEILLANCE VIDEOS

(71) Applicant: West Virginia University Board of Governors on Behalf of West Virginia University, Morgantown, WV (US)

(72) Inventors: Fei Dai, Morgantown, WV (US); Linjun Lu, Cambridge (GB)

(21) Appl. No.: 18/962,374

(22) Filed: Nov. 27, 2024

Related U.S. Application Data
(60) Provisional application No. 63/602,924, filed on Nov. 27, 2023.

(51) Int. Cl. G06V 10/764; G06V 10/26; G06V 10/772; G06V 10/82; G06V 20/54

(52) U.S. Cl. CPC G06V 10/764; G06V 10/26; G06V 10/772; G06V 10/82; G06V 20/54; G06V 2201/08

(57) ABSTRACT

Various examples are provided related to vehicle category classification from surveillance videos. In one example, a method to perform vehicle classification includes obtaining images of a vehicle and performing object detection and instance segmentation on the images of the vehicle resulting in wheel instance identification and vehicle classification. In another example, a system for performing vehicle classification includes an imaging device and a processing or computing device that can receive images of a vehicle; determine a wheel instance identification for the vehicle using instance segmentation and object detection; and classify the vehicle based at least in part upon the wheel instance identification. To facilitate this process, a dictionary encapsulating possible axle distribution patterns can be used for determination of classes.

### CROSS REFERENCE TO RELATED APPLICATIONS

This application claims priority to, and the benefit of, U.S. provisional application entitled “Systems and Methods for Automatic Vehicle Category Classification from Surveillance Videos” having Ser. No. 63/602,924, filed Nov. 27, 2023, which is hereby incorporated by reference in its entirety.

### STATEMENT REGARDING FEDERALLY SPONSORED RESEARCH OR DEVELOPMENT

This invention was made with government support under contract no. 69A3551847103 awarded by the Center for Integrated Asset Management for Multimodal Transportation Infrastructure Systems (CIAMTIS), a U.S. Department of Transportation University Transportation Center. The Government has certain rights in the invention.

### BACKGROUND

An advanced vehicle classification system has been recognized as an integral component of intelligent transportation systems that contribute to effective traffic management, planning, and regulation. The fine-grained categorization of vehicles beyond broad categories allows for a deeper understanding of traffic dynamics, enabling transportation authorities to optimize road infrastructure design, predict future transportation needs, implement efficient traffic control strategies, and schedule plans for pavement maintenance and rehabilitation. Furthermore, through the lens of fine-grained classification, it is also helpful for evaluating traffic-induced environmental impacts more accurately, given that the amount of airborne and noise emissions varies among different vehicle classes.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an example of a FHWA 13-category vehicle classification scheme, in accordance with various embodiments of the present disclosure.

FIG. 2 is an example of an overall framework of proposed method incorporating the vehicle classification scheme of FIG. 1, in accordance with various embodiments of the present disclosure.

FIG. 3 is an example of an architecture of cascade mask R-CNN, in accordance with various embodiments of the present disclosure.

FIGS. 4A and 4B are images of an example of a vehicle axle configuration identification, in accordance with various embodiments of the present disclosure.

FIGS. 5A and 5B are examples of a geometric model for axle spacing estimation, in accordance with various embodiments of the present disclosure.

FIG. 6 is an example of intermediate results of fine-grained vehicle classification, in accordance with various embodiments of the present disclosure.

FIG. 7 is an example of a dictionary of possible axle configuration vectors for each truck category, in accordance with various embodiments of the present disclosure.

FIGS. 8A-8D are examples of a pipeline of 3D bounding box construction, in accordance with various embodiments of the present disclosure.

FIG. 9 is an example of a boundary line estimation, in accordance with various embodiments of the present disclosure.

FIG. 10A is an example of samples of annotated images in customized traffic dataset, in accordance with various embodiments of the present disclosure.

FIG. 10B is an example of statistics of training and validation subset, in accordance with various embodiments of the present disclosure.

FIG. 11A is an example of a trend of performance metrics during model training, in accordance with various embodiments of the present disclosure.

FIG. 11B is an example of hyperparameters for model training, in accordance with various embodiments of the present disclosure.

FIG. 12 is an example of an experiment setup of field experiments, in accordance with various embodiments of the present disclosure.

FIGS. 13A and 13B are examples of vehicle identification results by Cascade Mask R-CNN. in accordance with various embodiments of the present disclosure.

FIG. 14A is an example of a fine-grained vehicle classification by proposed method, in accordance with various embodiments of the present disclosure.

FIG. 14B is an example of a fine-grained vehicle classification after verification, in accordance with various embodiments of the present disclosure.

FIG. 14C is an example of samples of misclassified vehicles, in accordance with various embodiments of the present disclosure.

FIG. 14D is an example of vehicle classification accuracy by previous methods, in accordance with various embodiments of the present disclosure.

FIG. 15 is a schematic diagram illustrating an example of processing or computing circuitry for implementing vehicle category classification, in accordance with various embodiments of the present disclosure.

### DETAILED DESCRIPTION

Disclosed herein are various examples related to vehicle category classification from surveillance videos. Reference will now be made in detail to the description of the embodiments as illustrated in the drawings, wherein like reference numbers indicate like parts throughout the several views.

In the following discussion, a general description of a methodology and system, and its components is provided, followed by a discussion of the operation of the same. Although the following discussion provides illustrative examples of the operation of various components of the present disclosure, the use of the following illustrative examples does not exclude other implementations that are consistent with the principals disclosed by the following examples.

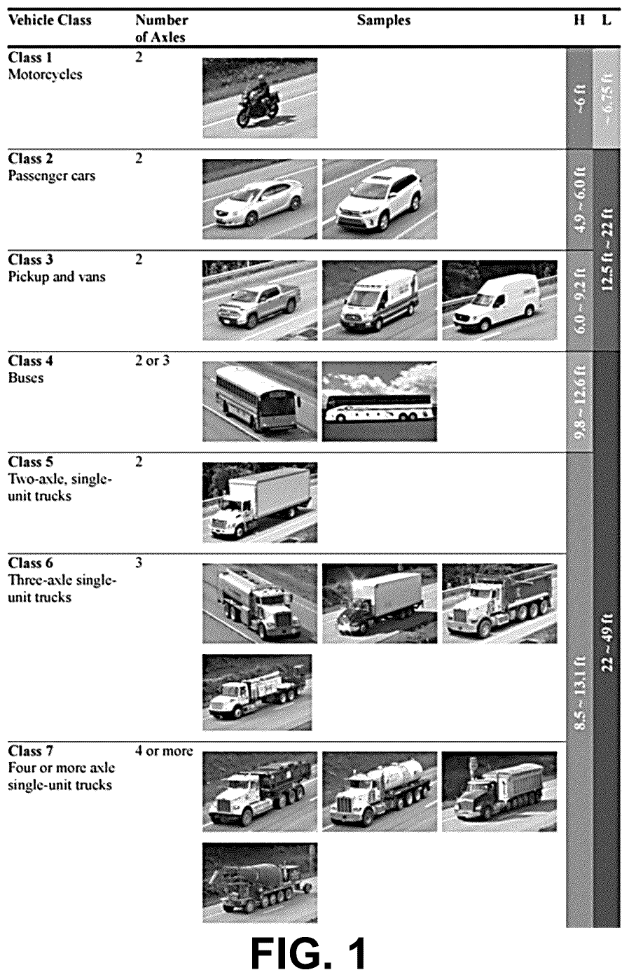

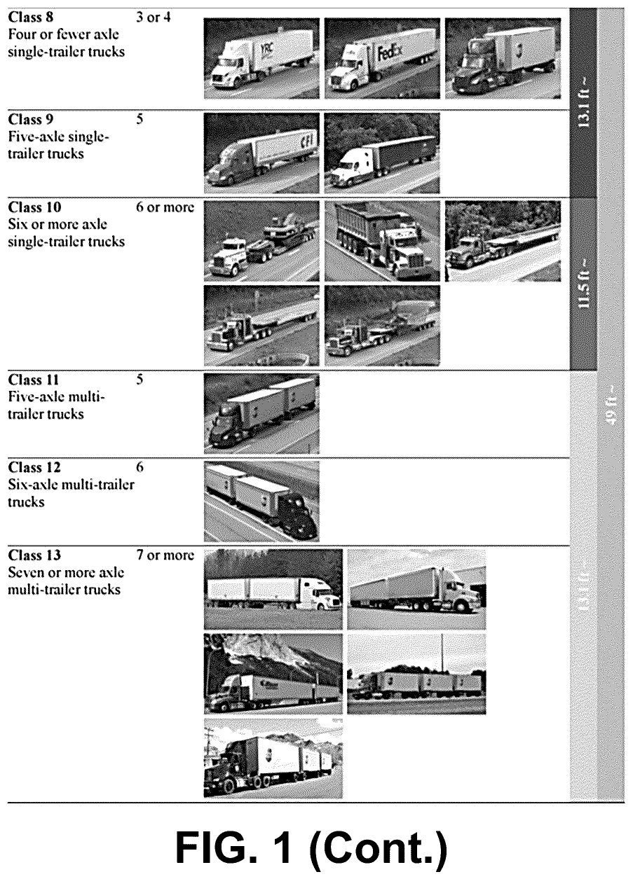

With reference to FIG. 1, shown is an example of a classification scheme according to various embodiments. The classification scheme can include first using vehicle appearance for classifying visually distinct vehicle types and then exploiting axle configuration as complementary features to distinguish interclass similar vehicle types. Additionally, a verification scheme can be introduced to validate the vehicle classification results by the proposed method, so that the overall vehicle classification accuracy can be further improved.

Considerable efforts have been made to use machine vision for vehicle classification; however, the existing methods are yet to be accurate enough, especially in classification of trucks (i.e., Classes 5˜13, as seen in FIG. 1), due in large part to their similarity in appearances (e.g., Classes 8 and 9, 11 and 12). A two-stage vision-based method for fine-grained vehicle classification was developed. It harvested combined semantic and geometric vehicle features extracted from surveillance videos. To facilitate this development, a dictionary was established, encapsulating possible truck axle distribution patterns on the road. This dictionary serves as the reference for achieving precise fine-grained truck classification, based on the observation that the trucks within different categories exhibit unique axle distribution patterns. Moreover, special attention was placed on filtering out the lift axles of vehicles because their position will affect the classification category into which the vehicle falls (i.e., Classes 6 and 7 in FIG. 1), which, however, is not inadequately handled by the existing vision-based methods.

### Vehicle and Wheel Instance Segmentation

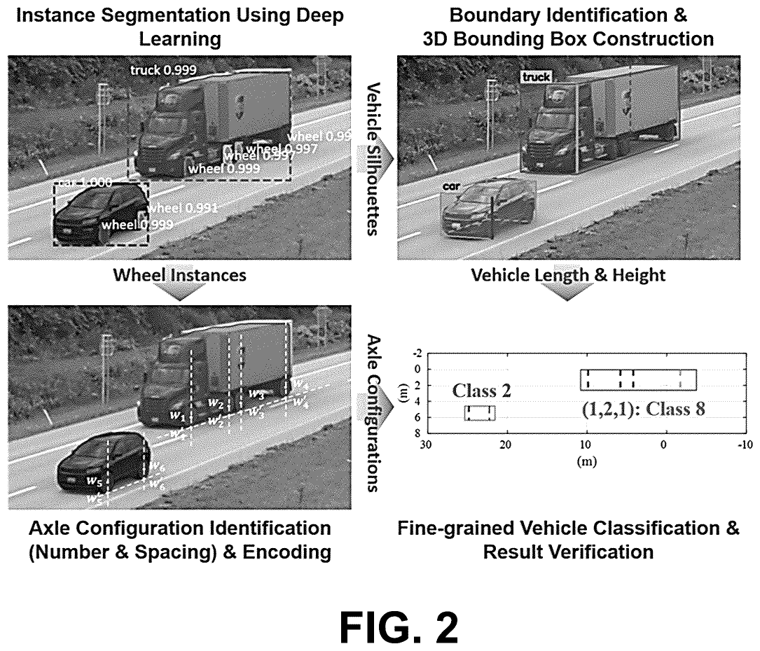

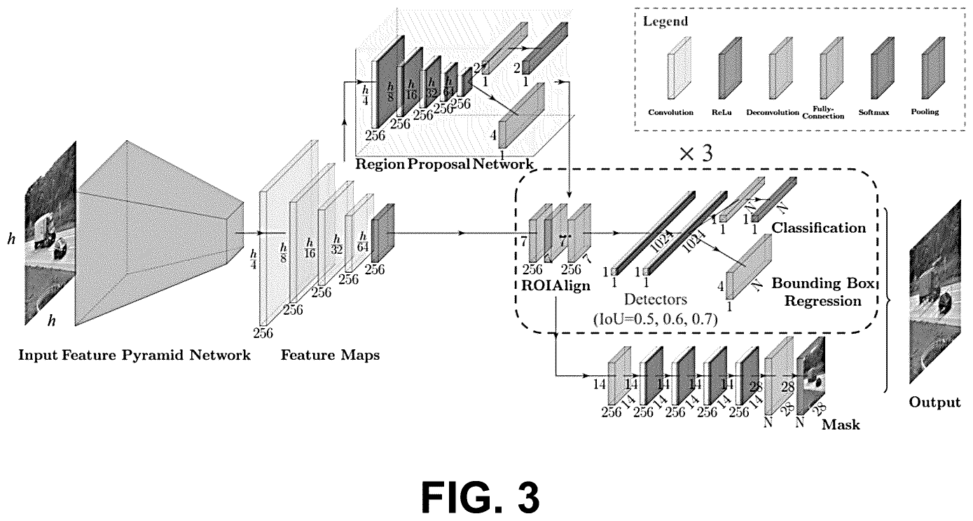

With reference to FIG. 2, shown is an overall framework of the proposed methodology. As the first step of the proposed method, Cascade Mask region-based convolutional neural network (R-CNN) is employed to segment the vehicle instances as well as their wheels in the recorded traffic images, which is essentially a two-stage anchor-based detection framework as illustrated in FIG. 3. Of note, the decision to use the Cascade Mask R-CNN was primarily motivated by two aspects. First, it adopts anchors with different scales and aspect ratios to generate a series of region proposals from feature maps. This enables the detection of objects across a large range of scales, thus making it particularly suitable for the detection of large-size trucks and small-size wheels. Second, the model incorporates a cascade architecture comprising a sequence of detectors that progressively refines the region proposals by training them with increasing intersection over union (IoU). It has been demonstrated that such a resampling mechanism can effectively deal with overfitting during the training and eliminate quality mismatches at the interface, thereby allowing for higher accuracy of object detection and better delineation of instance segmentation. In this study, the IoU thresholds are specified as 0.5, 0.6, and 0.7 for different detectors, respectively. However, like other CNN-based techniques, the Cascade Mask R-CNN relies on semantic information for object detection and segmentation. Consequently, it may fall short in differentiating the inter classes for which individual instances have a similar appearance, such as the case of truck classification in this study. Therefore, a coarse vehicle classification will be performed by the Cascade Mask R-CNN in this step, where the 13 vehicle classes are grouped into six categories based on their appearance, that is, motorcycle (Class 1), passenger car (Class 2), van (Class 3), pickup (Class 3), bus (Class 4), and truck (Classes 5˜13).

### Truck Axle Configuration Identification

The flow chart of FIG. 3 shows an example of the architecture, functionality, and operation of a possible implementation of the fine-grained vehicle classification software of FIG. 2. In this regard, each block represents a module, segment, or portion of code, which comprises one or more executable instructions for implementing the specified logical function(s). It should also be noted that in some alternative implementations, the functions noted in the blocks may occur out of the order noted in FIG. 3. For example, two blocks shown in succession in FIG. 3 may in fact be executed substantially concurrently or the blocks may sometimes be executed in the reverse order, depending upon the functionality involved, as will be further clarified hereinbelow.

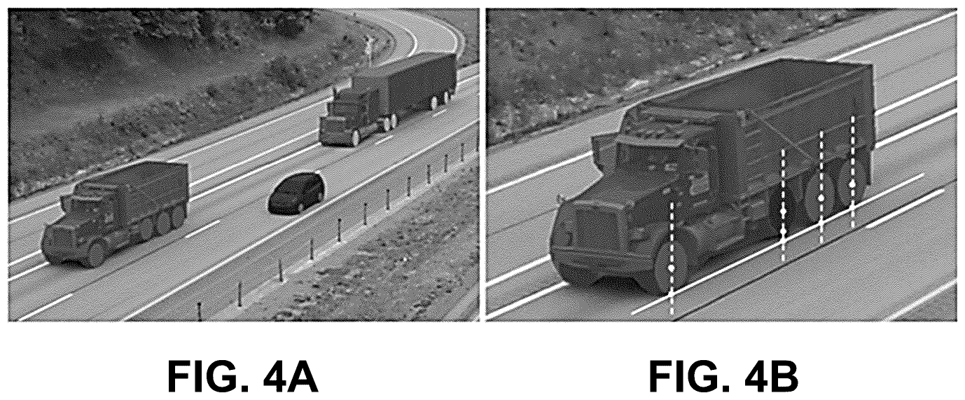

With reference to FIGS. 3, 4A, and 4B, shown is an example of an architecture of Cascade Mask R-CNN according to various embodiments and vehicle axle configuration identification of wheel grouping, and number counting and spacing estimation of valid axles, respectively. After the vehicle and wheel instances are detected in the images, the next step is to identify the axle configuration for every truck, including counting the number of valid axles and measuring their spacing. To this end, mask intersection over union (MaskIoU), an indicator that quantifies the degree of overlap between two instances, can be adopted to associate each wheel with its corresponding vehicle, so that the axle configuration of each vehicle can be identified individually. FIG. 4A shows an example of a wheel cluster with the use of the MaskIoU, in which the wheels belonging to the same vehicles are color-coded. A graphical diagram of the axle configuration identification is illustrated in FIG. 4B. It starts by computing the centroid of each wheel and projecting it vertically onto the ground plane. This can be achieved by determining the intersection of the line tangent to the vehicle's bottom and passing through the first vanishing point v₁ (i.e., the solid line) with the line passing through the vanishing points v₃ and the wheel's centroid (i.e., the dashed lines). Then, the distance between the lowest vertex of each wheel and its projected point on the ground plane can be calculated. If the distance exceeds a certain threshold (set as 18% of the distance between the wheel's centroid and its lowest vertex), the corresponding wheel can be identified as the lift wheel [e.g., the red lift wheel in FIG. 4B] and thereafter can be excluded from further analysis. In this way, the number of valid axles, namely the ones with loaded wheels [e.g., the blue loaded wheels in FIG. 4B], can be consequently counted. Following this, the axle spacing of the vehicle can be established by calculating the distances between the projected points of the adjacent loaded axles and converting the measurements from pixel units to metric units. Typically, such a unit conversion can be realized by estimating the homography between the image plane and the ground plane. However, the conventional methods of determining the homography matrix involve the manual setup of control points in the traffic scenarios and the measurement of their geospatial coordinates using measuring tools, which are usually time-consuming and would inevitably cause temporary lane closures. To tackle this hurdle, a labor-free solution was developed in this study, by which the axle spacing can be measured by referring to objects on the road plane with known lengths, such as lane dividers and road markings.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

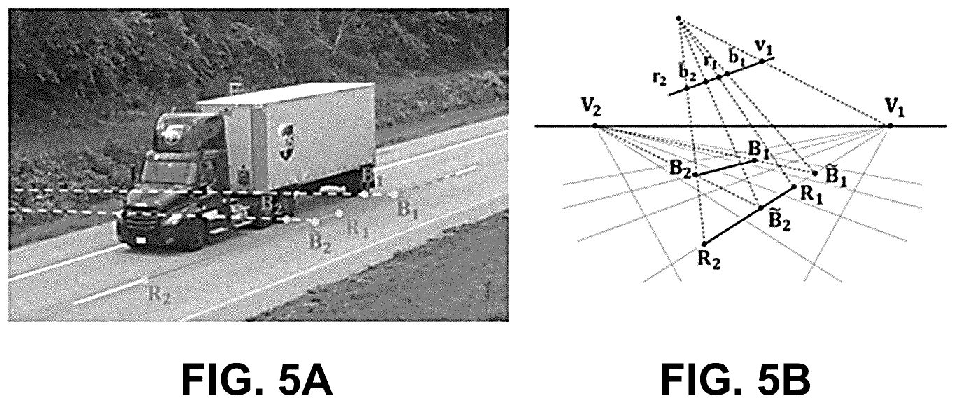

With reference to FIGS. 5A and 5B, shown are examples of a geometric model for axle spacing estimation according to various embodiments. The geometric model of the proposed solution for computing the axle spacing is depicted in FIG. 5B, where V₁ and V₂ are the locations of the vanishing points v₁ and v₂ in the real world. Both are the ideal points located at infinity with a third homogenous coordinate value of 0. B₁ and B₂ correspond to the projected points of the centroids of two adjacent wheels, while R₁ and R₂ stand for the two endpoints of a reference line (e.g., lane division) on the ground plane, respectively. The lines [symbol] B₁, B₂∞ and [symbol] R₁, R₂∞ are along the main road direction and intersect at the vanishing point V₁ as required. Now, constructing a line in the direction [symbol] V₂, B₂∞ that transfers B₂ onto the line [symbol] R₁, R₂∞. This transferred point is denoted as \tilde{B}₂. Similarly, the point \tilde{B}₁ corresponding to B₁ can be obtained by proceeding in the same way as that of the point B₂. By doing so, the line segment [symbol] B₁, B₂ [symbol] is successfully mapped onto the line [symbol] R₁, R₂∞, namely the length of the line segment [symbol] B₁, B₂∞ is equal to that of the line segment [symbol] \tilde{B}₁, \tilde{B}₂∞. As of now, a total of five collinear points are obtained, that is, R₂, \tilde{B}₂, R₁, \tilde{B}₁, and V₁. Particularly, given the four collinear points R₂, \tilde{B}₂, R₁, and \tilde{B}₁ thereof, their cross-ratio can be defined by

$$Cross ( {R}_{2} , {\tilde{B}}_{2} , {R}_{1} , {\tilde{B}}_{1} ) = \frac{\vert {R}_{2} {R}_{1} \vert \vert {\tilde{B}}_{2} {\tilde{B}}_{1} \vert}{\vert {\tilde{B}}_{2} {R}_{1} \vert \vert {R}_{2} {\tilde{B}}_{1} \vert} \qquad ( 1 )$$

where |·| stands for the operation of computing the signed distance between two points, e.g., |R₂R₁|=−|R₁R₂|. Since the cross-ratio of collinear points is invariant to projective transformation, it gives

$$Cross ( {R}_{2} , {\tilde{B}}_{2} , {R}_{1} , {\tilde{B}}_{1} ) = Cross ( {r}_{2} , {\tilde{b}}_{2} , {r}_{1} , {\tilde{b}}_{1} ) \qquad ( 2 )$$

or more explicitly as

$$\frac{\vert {R}_{2} {R}_{1} \vert \vert {\tilde{B}}_{2} {\tilde{B}}_{1} \vert}{\vert {\tilde{B}}_{2} {R}_{1} \vert \vert {R}_{2} {\tilde{B}}_{1} \vert} = \frac{\vert {r}_{2} {r}_{1} \vert \vert {\tilde{b}}_{2} {\tilde{b}}_{1} \vert}{\vert {\tilde{b}}_{2} {r}_{1} \vert \vert {r}_{2} {\tilde{b}}_{1} \vert} = {λ}_{1} \qquad ( 3 )$$

where r₂, \tilde{b}₂, r₁, and \tilde{b}₁ are the mapped locations of the points R₂, \tilde{B}₂, R₁, and \tilde{B}₁ on the image plane, respectively; and λ₁ is the scale factor. Likewise, as for another combination case of the points \tilde{B}₂, R₁, \tilde{B}₁, and V₁, it easily follows that

$$\frac{\vert {\tilde{B}}_{2} {\tilde{B}}_{1} \vert \vert {R}_{1} {V}_{1} \vert}{\vert {R}_{1} {\tilde{B}}_{1} \vert \vert {\tilde{B}}_{2} {V}_{1} \vert} = \frac{\vert {\tilde{b}}_{2} {\tilde{b}}_{1} \vert \vert {r}_{1} {v}_{1} \vert}{\vert {r}_{1} {\tilde{b}}_{1} \vert \vert {\tilde{b}}_{2} {v}_{1} \vert} = {λ}_{2} \qquad ( 4 )$$

where λ₂ is the scale factor in this new case. Since V₁ is located at infinity, the infinity terms |R₁V₁| and |\tilde{B}₂V₁| can be canceled in the numerator and denominator. Then, Eq. 4 is reduced to

$$\frac{\vert {\tilde{B}}_{2} {\tilde{B}}_{1} \vert}{\vert {R}_{2} {\tilde{B}}_{1} \vert} = \frac{\vert {\tilde{b}}_{2} {\tilde{b}}_{1} \vert \vert {r}_{1} {v}_{1} \vert}{\vert {r}_{1} {\tilde{b}}_{1} \vert \vert {\tilde{b}}_{2} {v}_{1} \vert} = {λ}_{2} \qquad ( 5 )$$

Combining Eqs. 3 and 5 and after some manipulations, one can consequently yield

$$\vert {B}_{2} {B}_{1} \vert = \vert {\tilde{B}}_{2} {\tilde{B}}_{1} \vert = \vert {\tilde{B}}_{2} {R}_{1} \vert + \vert {R}_{1} {\tilde{B}}_{1} \vert = \frac{{λ}_{2} ( {λ}_{1} - {λ}_{1} {λ}_{2} + {λ}_{2} )}{{λ}_{1} ( {λ}_{2} - 1 )} \vert {R}_{2} {R}_{1} \vert \qquad ( 6 )$$

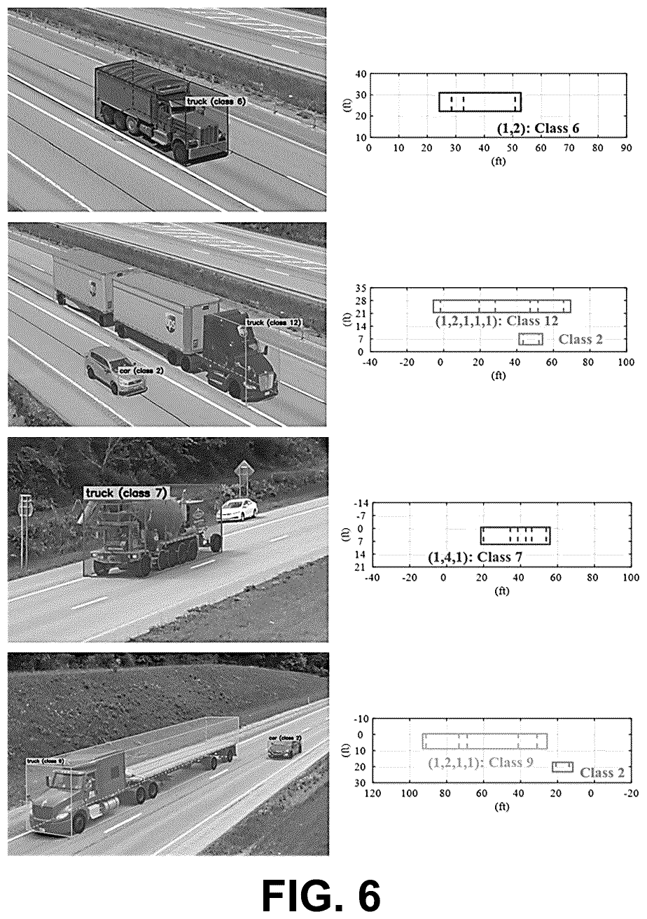

Noting that the coordinates of the points r₂, \tilde{b}₂, r₁, \tilde{b}₁, and v₁ can be directly read from the image, meaning that the values of the scale factors λ₁ and λ₂ are known a priori. It is natural that, therefore, the axle spacing |B₂B₁| can be calculated from Eq. 6 provided that the length of the reference line segmentation [symbol] R₁, R₂∞ is given. Some examples of axle spacing estimation are presented in FIG. 6. Furthermore, it should be noticed that utilizing this proposed solution for axle spacing estimate does not require prior knowledge of the intrinsic and extrinsic parameters of the camera. Thus, it is well-conditioned for different surveillance cameras without the need for specific adjustments.

### Axle Configuration Encoding and Fine-Grained Truck Classification

With reference to FIG. 6, shown is an example of the intermediate results of fine-grained vehicle classification according to various embodiments. Following the previous step, the obtained axle configuration of each truck is then encoded into a numerical vector by grouping the neighboring axles whose spacing does not exceed a predefined threshold, with each value in the output vector representing the number of neighbor axles. This is primarily motivated by the observation that the trucks within different categories exhibit unique axle distribution patterns. Based on the field survey, the spacing threshold is specified as 7 ft in this study. Notably, the numerical vector, namely the axle distribution pattern, produced by this encoding scheme for axle configuration achieves a dual purpose. That is, it not only efficiently captures the salient characteristic of each truck but also lends itself to easy recognition and processing by the algorithm for fine-grained classification. By applying the axle grouping scheme described above, the axle configurations of nine different types of trucks are encoded in vectors, serving as references for fine-grained classification.

### Verification Scheme for Vehicle Classification Results

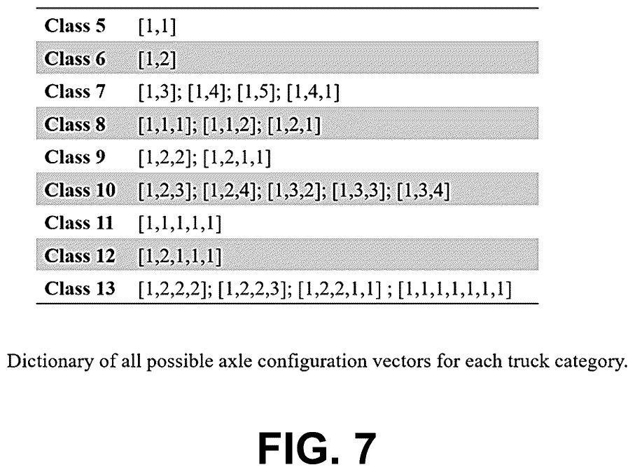

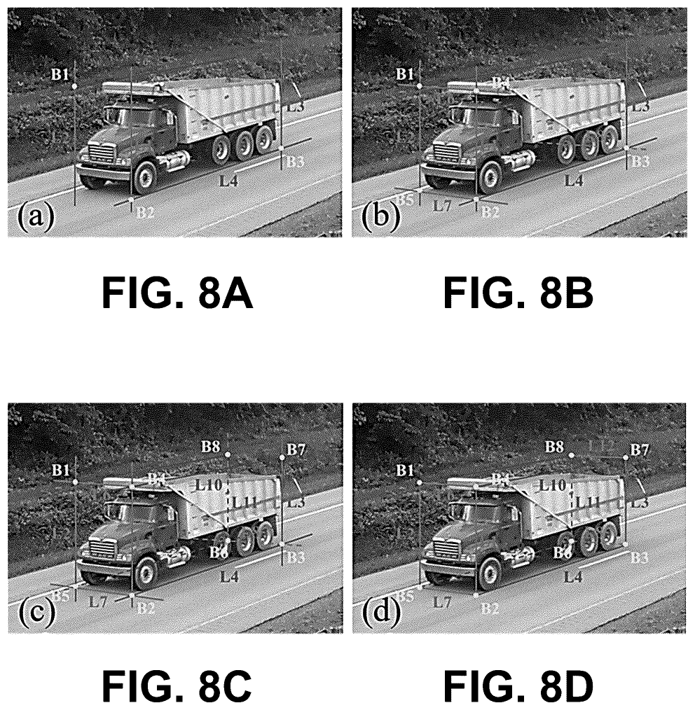

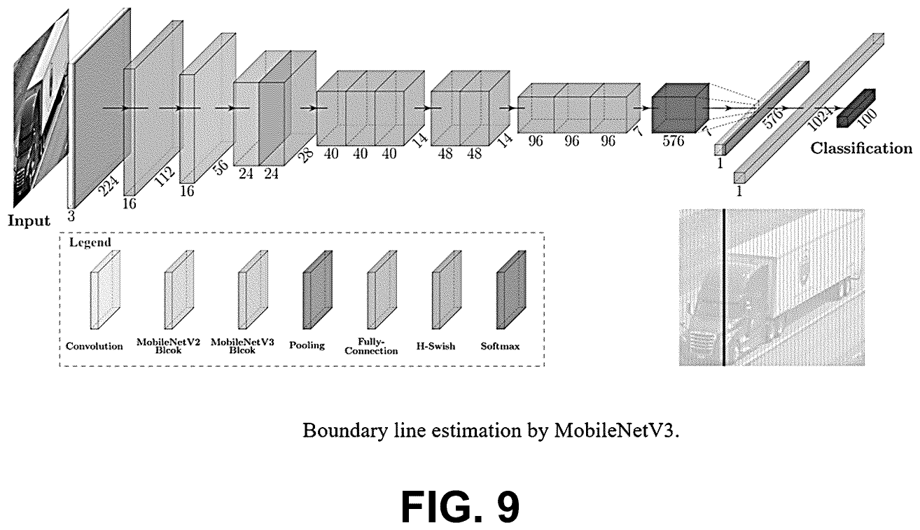

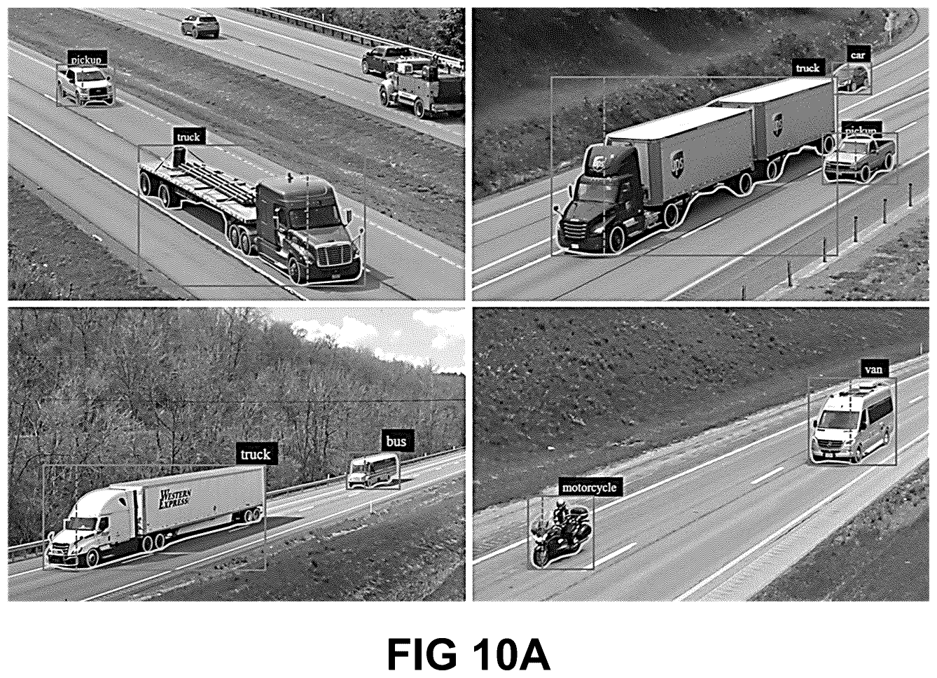

With reference to FIG. 7, shown is an example of a dictionary for possible axle configuration vectors for each truck category according to various embodiments. FIG. 7 displays the dictionary of possible axle configuration vectors for every truck category observed on the road (corresponding to the samples in FIG. 1). Once the axle configuration of one truck has been identified and encoded from the captured image, its fine-grained class can be conclusively determined by searching for its corresponding entry in the axle configuration vector dictionary. Some examples of fine-grained truck classification using the established axle configuration vector dictionary can be found in FIG. 6. Despite the effectiveness of the Cascade Mask R-CNN for object detection and instance segmentation, it may still suffer from false detection of wheels or cross-class misidentification among different vehicles, consequently leading to incorrect or even failed vehicle classification. To address this issue, the existing four-bin vehicle classification scheme is exploited as the heuristic to validate the vehicle classification results, which groups the 13 types of vehicles into four bins based on their length. In addition to this, the vehicle's height is also introduced in this study as supplementary information to enhance the robustness of the verification scheme. FIG. 1 shows the length (L) and height (H) bins to which 13 vehicle classes are designed to correspond. Accordingly, vehicles with dimensions that do not match their designated length and height bins will be flagged for manual reclassification. To execute this, the vehicles' 3D bounding boxes representing their 3D dimensional information need to be constructed on the recorded images. An example of the pipeline of 3D bounding box construction is illustrated in FIG. 8, which requires first determining the location of the boundary line between the vehicle's front and side faces. To this end, a lightweight deep learning model built upon MobileNet V3 is developed to estimate the boundary line as a classification task, as shown in FIG. 9. Specifically, each input image is evenly quantified into 100 vertical bins, based on which the MobileNet V3 outputs the probability of the boundary location belonging to a specific bin. In addition, to increase the boundary estimation accuracy, the MobileNet V3 takes the sub-images comprising the vehicle instances cropped out from the Cascade Mask R-CNN as the inputs. By doing so, it can exclude irrelevant information from the background and allow the MobileNet V3 to focus on relevant vehicle features for boundary location recognition and prediction.

With reference to FIGS. 8A, 8B, 8C, 8D and 9, shown are examples of steps 1-4 of pipeline of 3D bounding box construction, and an example of a boundary line estimation by MobileNetV3 respectively. The flow chart of FIG. 9 shows an example of the architecture, functionality, and operation of a possible implementation of the pipeline of 3D bounding box construction software of FIGS. 8A, 8B, 8C, and 8D. In this regard, each block represents a module, segment, or portion of code, which comprises one or more executable instructions for implementing the specified logical function(s). It should also be noted that in some alternative implementations, the functions noted in the blocks may occur out of the order noted in FIG. 9. For example, two blocks shown in succession in FIG. 9 may in fact be executed substantially concurrently or the blocks may sometimes be executed in the reverse order, depending upon the functionality involved, as will be further clarified hereinbelow.

Together with the detected vehicle region and three orthogonal vanishing points, the 3D bounding box of one vehicle can be constructed in the following steps. First, constructing four lines (L2˜5) passing through the vanishing points vᵣ v₃ and tangent the vehicle silhouette [see FIG. 8A]. Along with the boundary line L1, three vertices B1˜3 can be subsequently obtained. Following this, another three lines (L6˜8) can be constructed by drawing the lines passing through the vertices B1˜3 and the vanishing point v₂, leading to vertices B4 and B5 at the intersections of line L2 with lines L6 and L7, respectively [see FIG. 8B]. After that, a line (L9) passing through vertex B5 and the vanishing point 11 is constructed, which intersects with line L8 at vertex B6. Similarly, vertex B7 is determined by finding the intersection of line L3 and line L10 passing through the vertex B4 and the vanishing point 11 [see FIG. 8C]. Finally, the last vertex B8 can be obtained from the intersection of line L5 and line L11 passing through the vertex B6 and the vanishing point 13. With the eight vertices B1˜8 in place, the 3D bounding box can be ultimately constructed by progressively connecting the adjacent vertices pairwise until it forms a complete enclosure [see FIG. 8D]. Some examples of vehicle 3D bounding box construction are provided in FIG. 6. Once this is completed, the vehicle's height and length can be easily determined by computing the lengths of the vertical and longitudinal edges of the constructed 3D bounding box, and converting them into metric units through Eq. 6 and Single View Metrology with reference to the objects on the traffic scene with known lengths. If there exists a mismatch between the measured height and length and their expected values, the corresponding vehicle will be screened out for further manual reclassification.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

### Dataset Establishment

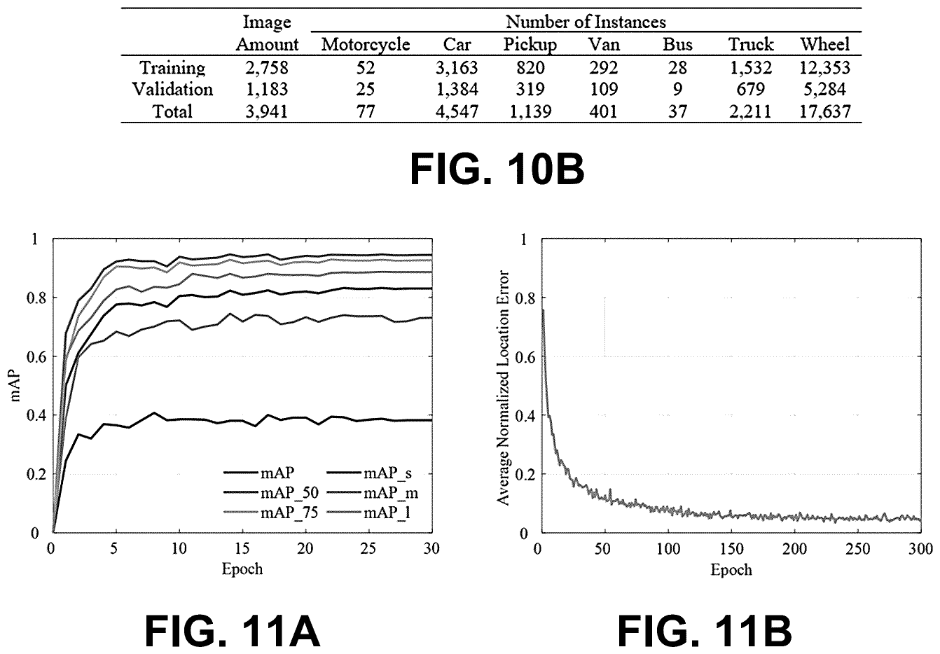

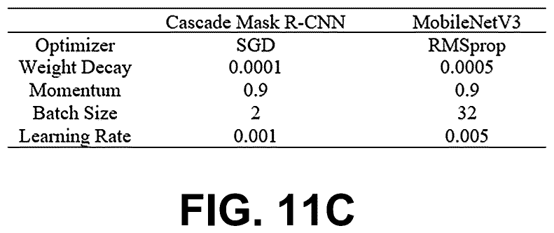

With reference to FIGS. 10 and 11, shown are samples of annotated images in customized traffic dataset and statistics of training and validation subsets respectively. A vehicle dataset was established by the authors for the model training of the Cascade Mask R-CNN and MobileNet V3, which contains a total of 3,941 images that were collected from different traffic scenarios with a resolution of 1,920×1,080 pixels. To prepare the training dataset for both models, the image labeling task was carried out hierarchically using the open-source image annotation program VGG Image Annotator. First, vehicle instances in each image were labeled by polygons that enveloped them closely. In particular, this annotation procedure followed two main principles: (1) the vehicles moving toward the camera are labeled, and (2) the vehicle wheels need to be labeled, regardless of their direction of movement. Following the developed methodology for vehicle classification, the vehicle instances were categorized into six groups: motorcycle, passenger car, van, pickup, bus, and truck. The collected image-polygon-class triples can be employed for training the Cascade Mask R-CNN model. Then, the vehicle instances could be cropped from the images by the minimum horizontal bounding boxes that encompass the corresponding labeled polygons, resulting in 7,917 sub-images being extracted in total. Within each horizontal bounding box, the location of the boundary between the vehicle's front and side faces could be marked with a vertical line, which could be subsequently encoded as a numerical value denoting the ratio of the distance between the boundary line and the left edge of the bounding box to the width of the bounding box. In addition, to ensure precise identification of the boundary line, any other vehicle instances within the bounding box could be masked. The resultant cropped sub-images and their associated location ratio were employed for training the MobileNet V3 model. Some representative samples of the annotated traffic images are shown in FIG. 10A, and the number of instances for each category is summarized in FIG. 10B.

### Model Training of Cascade Mask R-CNN and MobileNet V3

With reference to FIGS. 11A, 11B, and 11C, shown are examples of trend of performance metrics during model training and an example of a table of hyperparameters for model training, respectively. The model training tasks were conducted on one computer configured with one Geforce RTX 3060 Ti graphics processing unit (GPU), one Core i7-13700K central processing unit (CPU), and 32 GB of memory. As for the Cascade Mask R-CNN, residual neural network ResNet-101 was adopted as the backbone for feature extraction, chosen for its superior performance in addressing the gradient vanishing issue over other deep convolutional architectures. The established vehicle dataset was randomly split into training and validation subsets at a ratio of 8:2, yielding 3,152 images for training and 789 images for validation. To improve the model's ability to generalize, the training subset was augmented during the training process by implementing horizontal image flipping with a sampling rate of 50%. The hyperparameters used for training the Cascade Mask R-CNN model are provided in Table 2. Moreover, MS COCO evaluation indexes, including mAP, mAP50, mAP75, mAPS, mAPM, and mAPL, were adopted as metrics to evaluate and quantify model performance across different epochs. FIG. 11A plots the changes in different mAP metric values on the validation subset during the training process. It is evident that all AP metric values started converging and remaining stable after the 15th epoch, thereby the corresponding Cascade Mask R-CNN model trained at this epoch was finally selected for vehicle instance segmentation in the study.

The MobileNet V3 model was trained on the extracted vehicle instance sub-image dataset, of which 6,333 sub-images were used for training and the remaining 1,584 sub-images were used for validation. To accommodate for the MobileNetV3 architecture, all sub-images in both subsets were resized to 224×224 pixels using linear interpolation. FIG. 11C lists the hyperparameters that were specified for training the MobileNet V3 model. Herein, the normalized location error was exploited as the metric to evaluate the performance of the trained MobileNet V3 model for vehicle boundary line identification. It is calculated by dividing the distance between the estimated and the ground truth boundaries by the width of the associated sub-image. FIG. 11B illustrates the trend of the average normalized location error on the validation subset as the training progressed. Following the same model selection criteria applied previously, the MobileNet V3 model trained at the 200th epoch was finally chosen for this study.

### Experimental Setup and Implementation Details

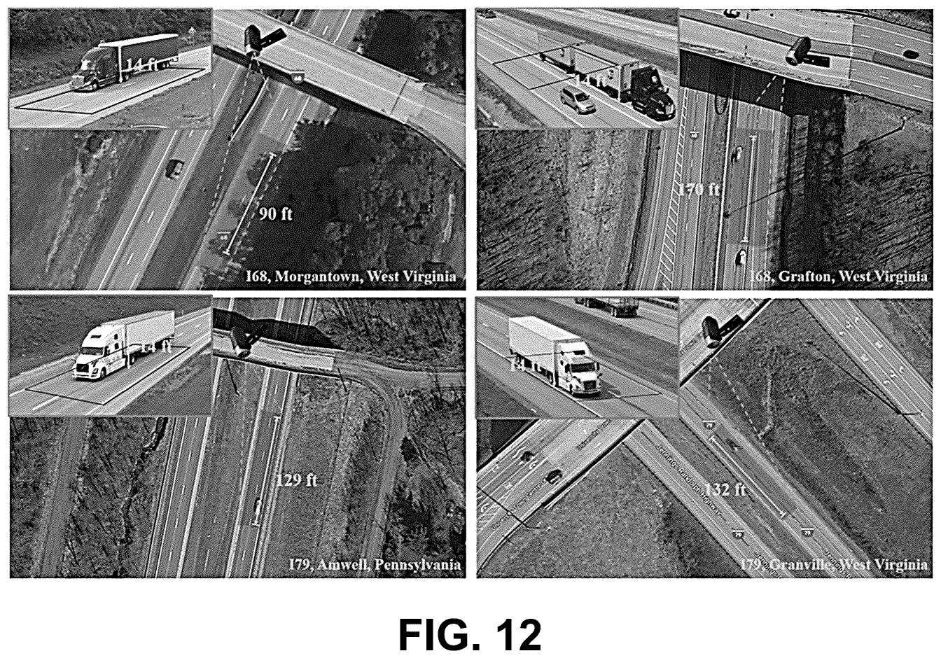

With reference to FIG. 12, shown is an example of an experiment setup of field experiments according to various embodiments. The field experiments were carried out to evaluate the performance of the proposed method for fine-grained vehicle classification as per the FHWA vehicle classification scheme. To increase the comprehensiveness of the performance evaluation, the field experiments can be conducted in four different traffic scenarios with different camera shooting angles and working (measurement) distances. An example of an experiment setup for each traffic scenario is schematically illustrated in FIG. 12. The camera used for traffic data acquisition is Panasonic HC-W580K, Kadoma, Japan. It has an inbuilt 50× optical zoom lens that allows for the adjustment of focal length to accommodate different working distances and the resolution requirement, if necessary. Special attention was given to ensure the data quality; thus, the camera shooting angles were carefully adjusted in each data acquisition mission to make sure that the vehicle wheels could be clearly seen in the recorded images. After being set up, the camera commenced working uninterruptedly in the HD resolution (1,920×1,080 pixels) and with a frame rate of 30 fps. The field of view of the camera under each traffic scenario is also shown in FIG. 12. To enable the proposed scheme for validating the vehicle classification results in each traffic scenario, one truck with the known height and the lane dividers on the road surface were employed as the references for estimating the height and length of each vehicle that appeared, respectively. The length of the lane divisions was measured from Google Maps. It is worth pointing out that, in order to reduce the potential impact of uncertainty related to reference object positioning on vehicle dimension estimation, longer reference objects are preferred for field applications.

The effectiveness of the proposed method for fine-grained vehicle classification and verification is highly dependent on the accuracy of vehicle and wheel instance segmentation. Therefore, it would be wise to select high-quality instances from the Cascade Mask R-CNN before proceeding with other steps in the proposed method. In this regard, certain challenges need to be well addressed. On the one hand, the distant wheel instances captured by the surveillance camera are usually too tiny and blurry to be reliably identified, which could result in the misclassification of corresponding trucks according to the developed vehicle classification scheme. On the other hand, the nearby vehicles might be partially out of the field of view of the camera, making it impossible for them to offer complete appearance and trustworthy wheel clues for further classification. To address these issues, a virtual detection zone was properly specified in the middle region of the surveilled view for each traffic scenario, as depicted in FIG. 12. Accordingly, only the vehicle silhouettes within this specified detection zone as well as their wheel instances will be retained for further processing. Additionally, a Deep Sort tracker was employed to lock onto identical vehicles based on spatial and appearance information, and continuously track them over sequential frames until they left the virtual detection zone. For each vehicle being tracked, classification and dimension estimation were carried out in the interim. Eventually, the classification and dimension estimation results of each vehicle can be registered through the statistical analysis of the observed measurement series, specifically, the mode for vehicle classification and the medians for height and length estimation.

### Vehicle and Wheel Instance Identification Accuracy

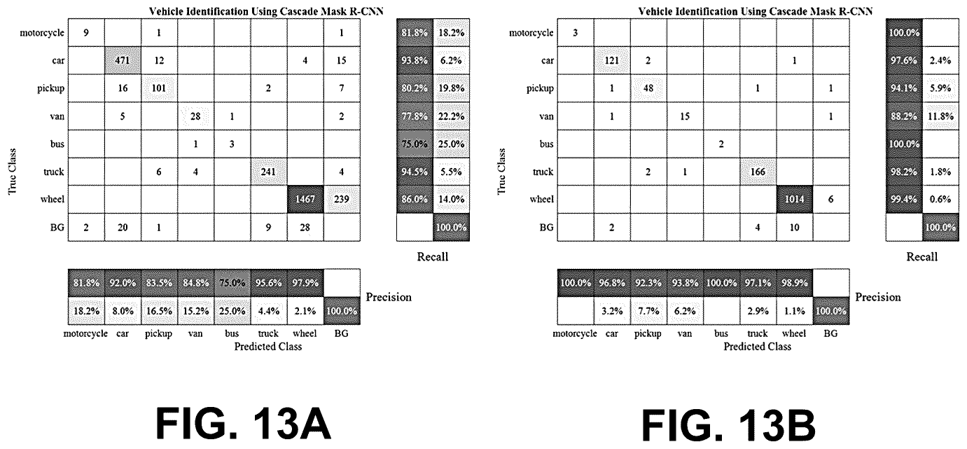

With reference to FIGS. 13A and 13B, shown are examples of vehicle identification results by Cascade Mask R-CNN; without virtual detection zone and with virtual detection zone, respectively. Firstly, the evaluation focuses on the performance of the trained Cascade Mask R-CNN model for coarse vehicle classification and instance segmentation. To do so, a series of frames can be randomly extracted from the recording traffic videos, producing a total of 340 images for testing. Concurrently, the vehicle and wheel instances in the obtained images can be manually labeled to serve as the ground truths for comparison, following the same labeling principles adopted during the creation of the traffic dataset. FIG. 13A presents an example of the identification results of different types of instances by the trained Cascade Mask R-CNN model in the form of a confusion matrix. Here, each row represents the instances in true classes, while each column represents the instances in predicted classes. As can be observed, the Cascade Mask R-CNN performed well in identifying the instances related to cars and trucks, achieving overall precision and recall of 92.0% and 93.8%, 95.6% and 94.5%, respectively. In contrast, the model exhibited a relatively lower performance in identifying the instances regarding motorcycles, pickups, vans, buses, and wheels with a maximum recall of no more than 86.0%. Particularly, it can be noticed that the reduced identification performance was highly characterized by instances of misclassification among the motorcycles, pickups, vans, and buses, as well as the misdetection of the wheels. A review of the raw images and ground truth annotations disclosed that these misclassifications and misdetections primarily occurred when instances appeared partially or far from within the field of view of the camera, which is unsurprisingly in line with the expectation as mentioned previously, thereby making it difficult for the trained deep learning model to detect and distinguish them correctly.

Then, focused attention was directed toward examining the effectiveness of the specified virtual detection zone in selecting high-quality vehicle and wheel instances. To fulfill this purpose, the identification accuracy of different types of instances can be re-evaluated after disposing of the instances that fell outside the specified virtual detection zone. Examples of the refined identification results are presented in FIG. 13B. By comparing these new outcomes with their counterparts in FIG. 13A, it is revealed that the specified virtual detection zone can effectively filter out the low-quality vehicle instances that might otherwise contribute to misclassification. Specifically, this refinement led to overall precision and recall rates that were higher than 92.3% and 88.2%, respectively. Furthermore, a substantial improvement in the identification recall for wheels can be observed upon the implementation of the virtual detection zone, rising significantly from 86% to a remarkable 99.4%. It is worth pointing out that such an improvement is of particular significance to the proposed method, as it allows for the precise retrieval of axle information for each vehicle inside the virtual detection zone. This, in turn, lays a strong foundation for the subsequent step of fine-grained truck classification in the proposed method. In light of these observed, it substantiates the importance and necessity of creating a well-defined detection zone in vision-based traffic applications to choose high-quality vehicle and wheel instances.

### Fine-Grained Vehicle Classification Accuracy

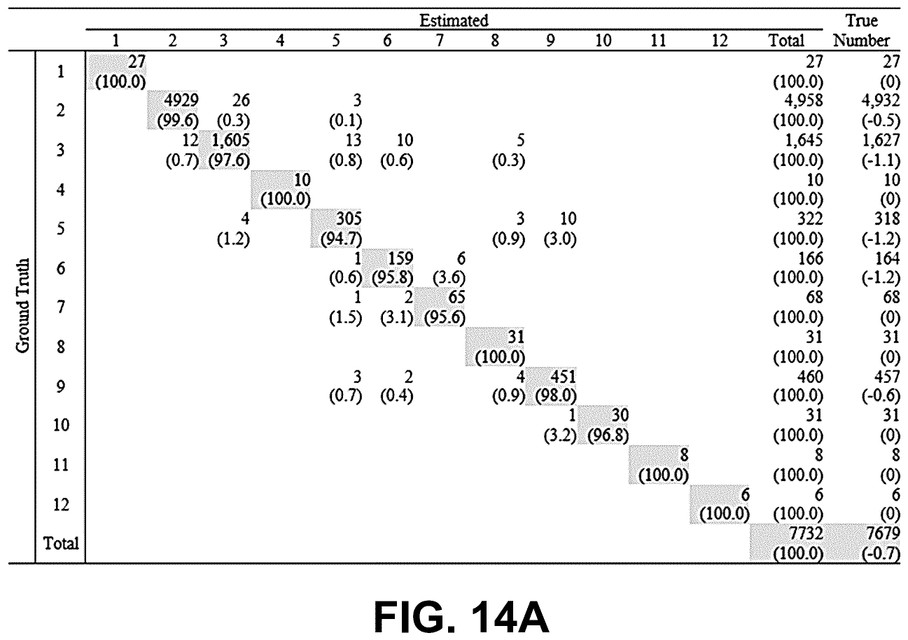

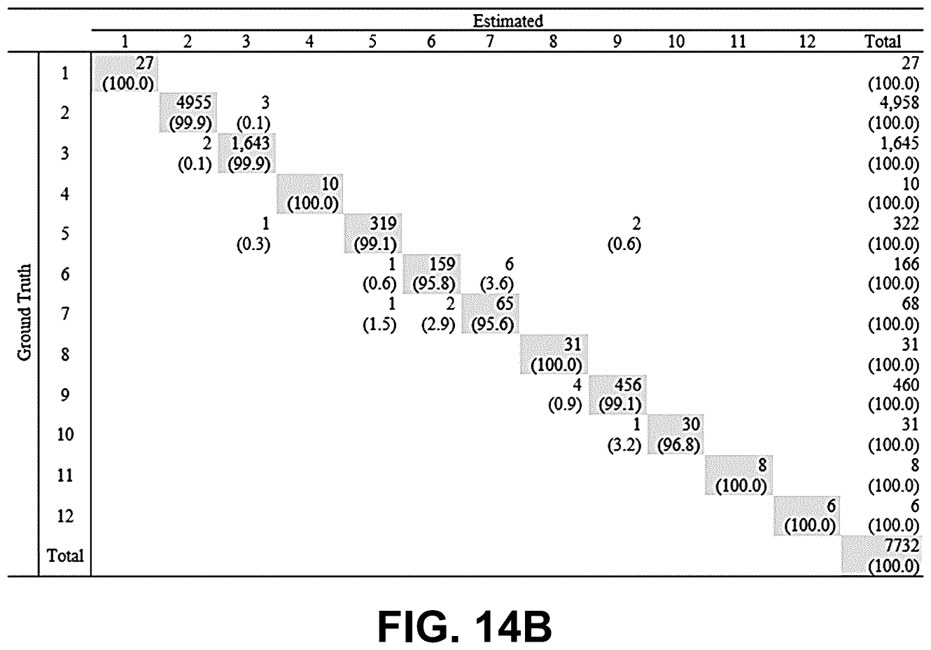

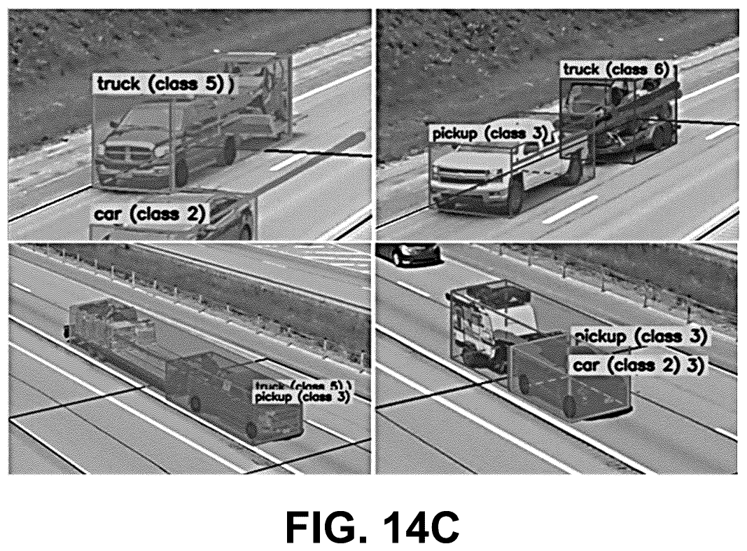

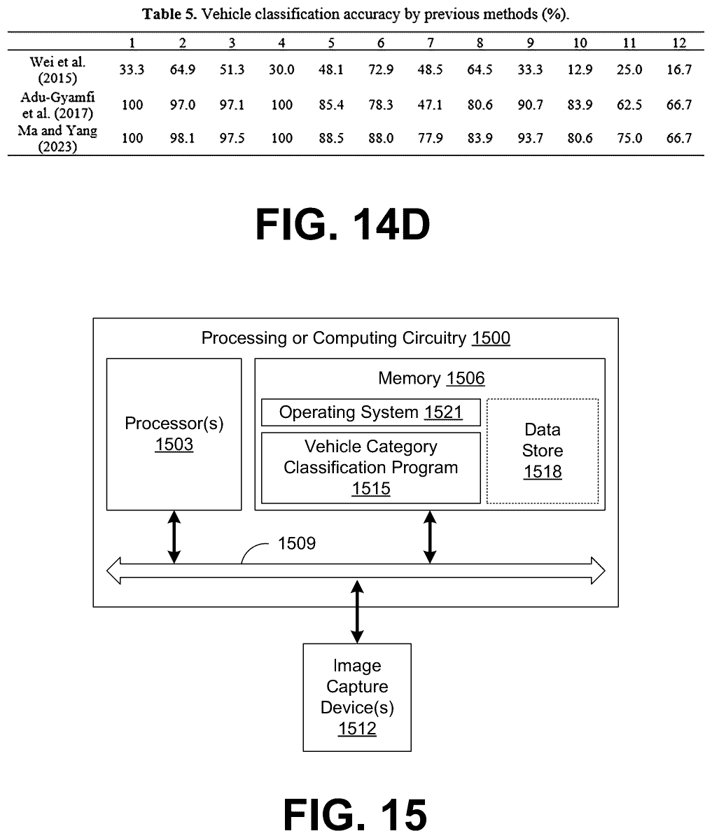

With reference to FIGS. 14A, 14B, 14C and 14D, shown are examples of the fine-grained vehicle classification by proposed method with percentage given in parentheses before verification, the fine-grained vehicle classification after verification, samples of misclassified vehicles, and vehicle classification accuracy by previous methods, respectively, according to various embodiments. All nine recorded videos were utilized to evaluate the performance of the proposed fine-grained vehicle classification method. To facilitate the evaluation process, the videos were manually labeled to include the true classes of the captured vehicles and their corresponding appearance timestamps. FIG. 14A summarizes the classification results for each vehicle class in comparison to their ground truth counterparts. Note: no vehicles of Class 13 were recorded during the field experiments, as they are illegal to operate in some states in U.S. and rarely seen in the real-world scenarios. As a result, the classification results for this class were not presented here. Additionally, the trucks with their wheels being severely occluded by the other vehicles were excluded from analysis, as incomplete wheel information would lead to incorrect classifications based on the proposed classification scheme. Note that it is safe to do so because this issue can be easily addressed by either mounting the surveillance camera at a higher altitude or deploying additional surveillance cameras to surveil the same traffic area from different perspectives in parallel. The results showed that the proposed method achieved satisfactory performance in fine-grained vehicle classification, with an overall accuracy of 98.6% across all vehicle classes and an accuracy of no lower than 94.7% for each class. Furthermore, the method demonstrated its capability in distinguishing different truck classes with similar appearance, such as Classes 6 and 7, Classes 8 and 9, and Classes 11 and 12. This accomplishment largely benefited from the developed axle configuration encoding scheme, which is capable of capturing the critical distinguishing characteristic among different truck classes, namely the axle distribution pattern. It should be noted that the total vehicle count exceeded the ground truth value by a marginal 0.7%. This discrepancy was mainly brought by the uncertainty introduced by the Deep Sort tracker when temporarily losing track of vehicles due to occlusions and subsequent re-tracking attempts within the virtual detection zone.

### Effectiveness of Classification Result Verification Scheme

The verification scheme was executed to validate the vehicle classification results obtained from the proposed method. Specifically, vehicle samples that exhibited disparities from their designated length and height bins were singled out for manual examination and were updated in FIG. 14A. The correspondingly refined classification results are displayed in FIG. 14B. As can be seen, the developed verification scheme shows commendable effectiveness in checking the classification results and seeking out the vehicles being falsely classified. This refinement contributed to a 1.1% improvement in the overall classification accuracy. Upon detailed examination of the misclassified vehicle samples, it is found that the majority misclassification occurred: (1) between cars and pickups (accounting for 35.8% of the total), (2) low-quality truck and wheel instance segmentation (accounting for 18.9% of the total), and (3) in the scenarios involving cars, pickups, and trucks towing flatbed trailers (accounting for 41.5% of the total) where the combination of the flatbed trailer and the car, pickup, or truck was identified as an entire truck. Some vehicle samples related to these three misclassification cases are shown in FIG. 14C. To address the challenge of misclassification and minimize the need for human intervention in image reviews, a direct solution lies in augmenting the training dataset with a more extensive collection of traffic images for deep learning model training.

To further evaluate the performance of the proposed method and demonstrate its superiority across different methods, comparisons with the existing vision-based methods were conducted. Also, to ensure a fair comparison, virtual detection zones were applied for selecting high-quality vehicle and wheel instances.

With reference to FIG. 14D, shown is a table representing an example of vehicle classification accuracy by previous methods according to various embodiments. FIG. 14D compiles the statistics of the classification results obtained by implementing three previous methods on the same set of traffic videos used in this study. As can be seen, the method fell significantly short of achieving the desired accuracy for the 13-category FHWA vehicle classification. This limitation can be traced back to a fundamental flaw inherent in their approach, characterized by substantial overlaps within the defined classes in both the length-based and axle-based classification schemes. Recalling FIG. 14A, it is observed that the classification accuracy of Classes 1˜4 by previous methods are comparable with the counterparts by the proposed method. Indeed, this is foreseeable, given that each of them employs state-of-the-art deep learning techniques to directly identify these four vehicle classes from the provided images. Nevertheless, when it comes to the fine-grained truck classification (Classes 5˜12), the performance of these two previous methods is noticeably degraded. This decline can be explained by the inherent overfitting issue associated with CNN-based techniques due to the visual similarity among different classes of trucks. It is also worth noting that the previously proposed method manages to achieve a performance improvement in truck classification by introducing axle location as supplementary information into the CNN model. Nevertheless, this improvement remains constrained by the fundamental challenge of distinguishing visually similar truck classes. Based on these observations, it can be concluded that addressing the 13-category FHWA vehicle classification task cannot be solely fulfilled by simply utilizing CNN-based techniques.

In addition to classification accuracy, image processing speed is another performance metric that can be evaluated when applying vision-based methods in traffic applications. The images can be processed at an appropriate speed at which the object tracker (e.g., Deep Sort tracker) can function properly to enable the accurate statistical analysis of vehicle class measurements and prevent repeat vehicle counting. In order to provide constant and accurate vehicle location tracking across a series of frames, the ideal object tracker processing speed should not be less than 12.5 fps. Based on the computational setup adopted in this study, the proposed method can achieve an average processing speed of 13.8 fps for vehicle classification and counting, indicating that it can work in real time with a safe margin. In addition, it is worth mentioning that another significant advantage of the proposed method compared to existing approaches is its scalability. The existing vision-based method for vehicle classification utilizes the accurate extraction of detail and salient vehicle features from traffic images by the trained machine learning/deep learning models. However, given that vehicle attributes often exhibit variations from one region or country to another, implementing the existing vision-based methods can necessitate the creation and annotation of separate vehicle image datasets for model training. This is important to accommodate diverse vehicle sizes and appearances but can significantly constrain their applicability. In contrast, the proposed methodology only employs the deep learning model for coarse vehicle classification, thus the trained model has higher robustness for classifying the vehicles that have not been seen before. Also, a comprehensive survey revealed that vehicles categorized according to different countries' classification schemes also exhibit unique axle distribution patterns. Consequently, it is reasonable to assert that the proposed approach can be readily expanded and adapted for fine-grained vehicle classification in diverse regions or countries. The only requisite modification would involve revising the vehicle dictionary to align with vehicle axle distribution patterns prevalent in the target region or country.

In addition, the occlusion issue can be addressed to avoid misclassification of vehicles as well as a vehicle undercount. Installation of several surveillance cameras concurrently at different locations and with various surveillance view angles so that each camera can be configured to cover certain lanes explicitly without being obstructed by the vehicles in other lanes can overcome this challenge. In this regard, the camera locations can be chosen to optimize surveillance view angles under different traffic scenarios.

This disclosure has presented a vision-based method tailored to the demanding task of classifying vehicles into the 13-category FHWA classification scheme by leveraging combined semantic and geometric features extracted from surveillance videos. Through extensive field experiments, it has been demonstrated that the proposed method can successfully recognize and distinguish vehicles from different categories with promising accuracy. The contribution of this study lies in providing a cost-efficient and non-intrusive solution for fine-grained vehicle classification in support of different intelligent transportation applications. It stands as one of the linchpins for enhancing traffic management, safety measures, operational efficiency, and sustainability practices while considering the diverse range of vehicles on modern roadways. Furthermore, the proposed method's scalability is a notable asset, offering adaptability for fine-grained vehicle classification in diverse regions and countries. Achieving this flexibility includes the adjustment of the vehicle dictionary to align with the prevalent vehicle axle distribution patterns specific to the target region or country. This versatility reinforces the method's applicability across a wide array of geographic contexts.

With reference to FIG. 15, shown is a schematic block diagram illustrating an example of processing or computing circuitry 1500. In some embodiments, among others, the processing or computing circuitry 1500 may include a processing or computing device such as, e.g., a smartphone, tablet, computer, etc. As illustrated in FIG. 15, the processing or computing circuitry 1500 can include, for example, a processor 1503 and a memory 1506, which can be coupled to a local interface 1509 comprising, for example, a data bus with an accompanying address/control bus or other bus structure as can be appreciated. To this end, the processing or computing circuitry 1500 may comprise, for example, at least one server computer or like device, which can be utilized in a cloud-based environment. In some embodiments, the processing or computing circuitry 1500 can include one or more network interfaces that may comprise, for example, a wireless transmitter, a wireless transceiver, and a wireless receiver. The network interface can communicate to a remote computing device using, e.g., a Bluetooth protocol or other wireless protocol.

In some embodiments, the processing or computing circuitry 1500 can include one or more network/communication interfaces. The network/communication interfaces may comprise, for example, a wireless transmitter, a wireless transceiver, and/or a wireless receiver. As discussed above, the network interface can communicate to a remote computing device using a Bluetooth, WiFi, or other appropriate wireless protocol. As one skilled in the art can appreciate, other wireless protocols may be used in the various embodiments of the present disclosure. In addition, the processing or computing circuitry 1500 can be in communication with one or more image capture device(s) 1512 such as, e.g., an optical imaging device, a thermal imaging device (e.g., an infrared camera), and/or other appropriate imaging device, any of which may be configured to capture video images. In some implementations, image capture device(s) 1512 can be incorporated in a device comprising the processing or computing circuitry 1500 and can interface through the locate interface 1509.

Stored in the memory 1506 can be both data and several components that are executable by the processor 1503. In particular, stored in the memory 1506 and executable by the processor 1503 can be a vehicle category classification program 1515 and potentially other application program(s). Also stored in the memory 1506 may be a data store 1518 and other data. In addition, an operating system 1521 may be stored in the memory 1506 and executable by the processor 1503. The memory is defined herein as including both volatile and nonvolatile memory and data storage components. Volatile components are those that do not retain data values upon loss of power. Nonvolatile components are those that retain data upon a loss of power. Thus, the memory 1506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, optical disc such as compact disc (CD) or digital versatile disc (DVD), magnetic tapes accessed via an appropriate tape drive, holographic storage, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1503 may represent multiple processors 1503 and/or multiple processor cores (e.g., of a graphics processing unit), and the memory 1506 may represent multiple memories 1506 that operate in parallel processing circuits, respectively. In such a case, the local interface 1509 may be an appropriate network that facilitates communication between any two of the multiple processors 1503, between any processor 1503 and any of the memories 1506, or between any two of the memories 1506, etc. The local interface 1509 may comprise additional systems designed to coordinate this communication, including, for example, performing load balancing. The processor 1503 may be of electrical or of some other available construction.

A number of software components can be stored in the memory 1506 and can be executable by the processor 1503. An executable program may be stored in any portion or component of the memory 1506. In this respect, the term “executable” means a program file that is in a form that can ultimately be run by the processor 1503. Examples of executable programs may be, for example, a compiled program that can be translated into machine code in a format that can be loaded into a random access portion of the memory 1506 and run by the processor 1503, source code that may be expressed in proper format such as object code that is capable of being loaded into a random access portion of the memory 1506 and executed by the processor 1503, or source code that may be interpreted by another executable program to generate instructions in a random access portion of the memory 1506 to be executed by the processor 1503, etc. In particular, stored in the memory and executable by the processor can be a vehicle category classification program, an operating system and potentially other applications. Also stored in the memory may be a data store and other data. It is understood that there may be other applications that are stored in the memory and are executable by the processor as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

Although the vehicle category classification program 1515 and other application program(s) or systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein. Also, any logic or application described herein, including the vehicle category classification program 1515, that comprises software or code can be embodied in any non-transitory computer-readable medium for use by or in connection with an instruction execution system such as, for example, a processor 1503 in a computer system or other processing circuitry, device or system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The automated fine-grained vehicle classification using combined semantic and geometric features extracted from surveillance videos program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the certain embodiments of the present disclosure includes embodying the functionality of the preferred embodiments of the present disclosure in logic embodied in hardware or software-configured mediums.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method to perform vehicle classification, comprising:
obtaining, via at least one computing device, a plurality of images of at least one vehicle; and
performing object detection and instance segmentation on the plurality of images of the at least one vehicle resulting in wheel instance identification and vehicle classification of at least one motorcycle, at least one passenger car, at least one pickup or van, at least one bus, or at least one truck, or a combination thereof.

2. The method of claim 1, further comprising:
preparing a truck axle configuration dictionary;
obtaining a truck axle configuration from the plurality of images of the at least one truck;
identifying the truck axle configuration of the at least one truck; and
comparing the truck axle configuration of the at least one truck to the truck axle configuration dictionary resulting in a vehicle truck classification of the at least one truck.

3. The method of claim 2, wherein the vehicle truck classification comprises at least nine categories.

4. The method of claim 1, wherein object detection and instance segmentation are performed using view geometry.

5. The method of claim 1, wherein vehicle classification is verified using a length and a height of the vehicle.

6. The method of claim 1, wherein the vehicle classification comprises at least five categories.

7. The method of claim 1, wherein object detection and instance segmentation are performed using a cascade mask region-based convolutional neural network.

8. The method of claim 1, wherein vehicle classification occurs while at least one vehicle is on-road.

9. A system for performing vehicle classification, comprising:
at least one imaging device;
at least one processing or computing device communicatively coupled with the at least one imaging device, the at least one processing or computing device configured to at least:
receive a plurality of images of at least one vehicle;
determine a wheel instance identification for the at least one vehicle using instance segmentation and object detection; and
classify the at least one vehicle based at least in part upon the wheel instance identification.

10. The system of claim 9, wherein the at least one processing or computing device is further configured to:
prepare a vehicle axle configuration dictionary;
obtaining a vehicle axle configuration from the plurality of images of at least one vehicle;
identifying the vehicle axle configuration of the at least one vehicle; and
comparing the vehicle axle configuration of the at least one vehicle to the vehicle axle configuration dictionary resulting in a vehicle classification of the at least one vehicle.

11. The system of claim 10, wherein the vehicle classification comprises at least nine categories.

12. The system of claim 9, wherein object detection and instance segmentation are performed using view geometry.

13. The system of claim 9, wherein the vehicle classification comprises at least five categories.

14. The system of claim 9, wherein object detection and instance segmentation is performed using a cascade mask region-based convolutional neural network.

15. The system of claim 9, wherein inter-vehicle classification occurs while at least one vehicle is on-road.

16. The non-transitory computer-readable storage medium, comprising machine-readable instructions that, when executed by a processor of a computing device, cause the computing device to at least:
receive a plurality of images of at least one vehicle; and
determine a wheel instance identification for the at least one vehicle using instance segmentation and object detection; and
classify the at least one vehicle based at least in part upon the wheel instance identification.

17. The non-transitory, computer-readable medium of claim 16, further causing the computing device to at least:
prepare a truck axle configuration dictionary;
obtain a truck axle configuration from the plurality of images of at least one truck;
identify the truck axle configuration of at least one truck; and
compare the truck axle configuration of at least one truck to the truck axle configuration dictionary resulting in intra-vehicle classification of at least one truck.

18. The non-transitory, computer-readable medium of claim 16, wherein object detection and instance segmentation is performed using a cascade mask region-based convolutional neural network.

19. The non-transitory, computer-readable medium of claim 16, wherein object detection and instance segmentation are performed using view geometry.

20. The non-transitory, computer-readable medium of claim 16, wherein inter-vehicle classification occurs while at least one vehicle is on-road.
